(19) United States
(12) Patent Application Publication
(10) Pub. No.: US 2016/0104249 A1
(43) Pub. Date: Apr. 14, 2016

(54) POLICY MANAGEMENT SYSTEM AND METHOD

(71) Applicant: Webcetera, L.P., Lewisville, TX (US)

(72) Inventors: Nagaraj V. Rao, Flower Mound, TX (US); Braden P. Polansky, Southlake, TX (US)

(21) Appl. No.: 14/876,343

(22) Filed: Oct. 6, 2015

Related U.S. Application Data
(60) Provisional application No. 62/061,456, filed on Oct. 8, 2014.

(51) Int. Cl. G06Q 40/08

(52) U.S. Cl. CPC G06Q 40/08

(57) ABSTRACT

A policy management system includes an analysis module executable by a processor, the analysis module configured to identify risk factors associated with a policy of insurance offered by an insurance provider for a risk, the analysis module configured to apply weighted values to the identified risk factors, and wherein the analysis module is configured to combine the applied weighted values to determine whether the risk should be marketed to another insurance provider.

### BACKGROUND

Insurance agents or insurance brokers generally provide consumers with insurance services, such as providing an insurance premium estimate (a.k.a., a rate quote) for a variety of types of insurance products (e.g., automobile insurance, health insurance, life insurance, home insurance, etc.), providing notices of policy renewals, instituting changes to policies, etc. An insurance agent may be affiliated with one insurance provider or may interact with a number of different insurance providers (e.g., an insurance broker or independent insurance agent).

Insurance agents may use various tools to manage insurance-related information for their customers, including an agency management system. An agency management system may comprise a centralized, computer-implemented system that assists with the management of insurance-related information. The system may be used to remind customers of insurance policy renewals, interact with insurance carriers to institute policy changes, etc.

### BRIEF SUMMARY

According to one aspect of the present disclosure a method and technique for policy management is disclosed. A policy management system includes an analysis module executable by a processor, the analysis module configured to identify risk factors associated with a policy of insurance offered by an insurance provider for a risk, the analysis module configured to apply weighted values to the identified risk factors, and wherein the analysis module is configured to combine the applied weighted values to determine whether the risk should be marketed to another insurance provider.

### BRIEF DESCRIPTION OF THE DRAWINGS

The accompanying drawings incorporated in and forming a part of the specification illustrate several aspects of the present disclosure and, together with the description, serve to explain the principles of the present disclosure. In the drawings:

FIG. 1 is a diagram illustrating a network of data processing systems in which an embodiment of a policy management system according to the present disclosure may be implemented;

FIG. 2 is a diagram illustrating a graph of aggregate policy data derived by a policy management system according to the present disclosure;

FIG. 3 is a flow diagram illustrating an embodiment of a policy management method according to the present disclosure;

FIG. 4 is a flow diagram illustrating another embodiment of a policy management method according to the present disclosure; and

FIG. 5 is a diagram illustrating an embodiment of a displayed policy comparison analysis performed by a policy management system according to the present disclosure.

### DETAILED DESCRIPTION OF THE DRAWINGS

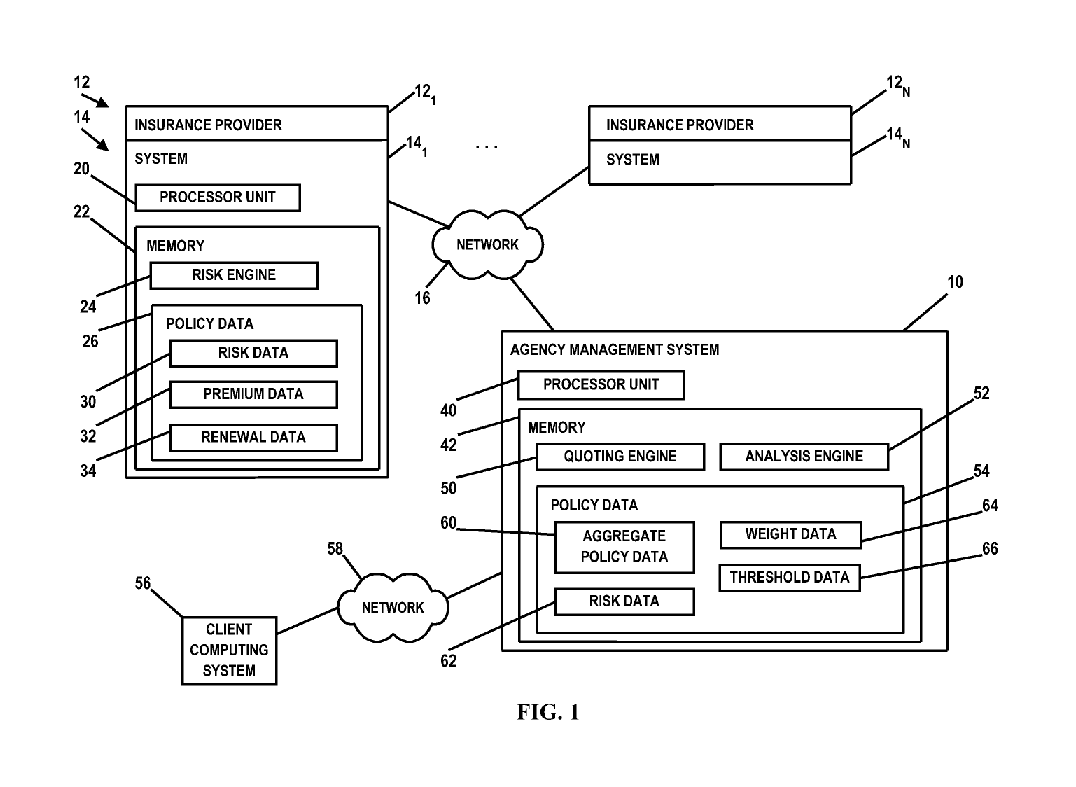

Referring now to FIG. 1, an embodiment of an agency management system 10 is illustrated. As will be more fully explained below, system 10 enables an agency (or agent of an agency) to determine whether a consumer's insurance policy needs should be marketed to additional/other insurance providers. For example, in the context of an insurance policy renewal, system 10 automatically evaluates numerous criteria to determine whether the terms of a policy renewal are reasonable. System 10 automatically aggregates insurance information from various insurance providers and analyzes the consumer's policy information to determine whether the policy is reasonable and/or whether the risks associated with the policy should be marketed/re-marketed to other insurance providers. An agency (or agent) as used herein may be any entity, person or group of persons that sells or otherwise provides an insurance product to a consumer (e.g., independent of whether the seller is representing the interests of the consumer or the insurance provider). It should be understood that any type of policy, new or renewal, may be evaluated according to the present disclosure.

In the embodiment illustrated in FIG. 1, a number of different insurance providers 12 (e.g., insurance providers 12₁-12ₙ) each has a data processing system 14 associated therewith (e.g., respective systems 14₁-14ₙ. Each system 14 may comprise a server or other type of computing platform accessible through a network 16 by agency management system 10. Network 16 may comprise the Internet or another suitable network (wired and/or wireless) for communicating information between systems 10 and 14 such as, for example, a wide area network (WAN), local area network (LAN), intranet, extranet, etc., or any combination thereof. Each system 14 may comprise a processor unit 20 and a memory 22. Memory 22 may include a risk engine 24 and policy data 26. Risk engine 24 may be configured to analyze various risk factors, determine whether to insure a risk, and, if so, calculate a premium associated with a policy for insuring the risk. Risk engine 24 may be implemented in any suitable manner using known techniques that may be hardware-based, software-based, or some combination of both. For example, risk engine 24 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system).

Policy data 26 may comprise various types of information associated an insurance product such as, but not limited to, risk data 30, premium data 32 and renewal data 34. Risk data 30 may comprise various types of information associated with a risk that may be insured by a particular provider 12 such as, but not limited to, the type of policy being requested, the factors used for evaluating the risk (e.g., for an automobile policy, the type of automobile, the age of the driver, driver history information, etc.). Premium data 32 may comprise the premium charged by the provider 12 for insuring the risk. Renewal data 34 may comprise information associated with a renewal of a policy of insurance (e.g., any change in premium for renewing a policy of insurance after an initial term of the policy).

In the illustrated embodiment, system 10 comprises a processor unit 40 and a memory 42. In FIG. 1, memory 42 includes a quoting engine 50, an analysis engine 52 and policy data 54. Quoting engine 50 may be configured to receive information associated with a request from a consumer for an insurance product and to submit a request for a quote to one or more insurance providers 12 for insuring the applicable risk. For example, a consumer may use a client computing system 56 (e.g., a desktop computer, laptop computer, mobile phone, tablet computer, etc.) to input various types of information in connection with a request for an insurance product quote. The request may be submitted to system 10 via a network 58, which may comprise the Internet or another suitable network (wired and/or wireless) for communicating information between systems 56 and 10 such as, for example, a wide area network (WAN), local area network (LAN), intranet, extranet, etc., or any combination thereof. It should be understood that a broker may also manually input such information into system 10. Quoting engine 50 may then communicate with system 14 of various providers 12 to retrieve a quote for insuring the risk (e.g., from a respective risk engine 24).

Analysis engine 52 may be configured to analyze various types of information associated with an offer of a policy, or an offer of policy renewal, made by a provider 12 to a consumer to determine whether the terms of such offer is reasonable given the unique circumstances or factors associated with the risk. For example, analysis engine 52 may be configured to analyze an offer of policy (initial offer or a renewal) and determine whether the premium (or any change in premium for such policy renewal) is reasonable based on the risk factors (or changes in risk factors) associated with such policy renewal. Analysis engine 52 and/or quoting engine 50 may be implemented in any suitable manner using known techniques that may be hardware-based, software-based, or some combination of both. For example, analysis engine 52 and/or quoting engine 50 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system.

Policy data 54 may comprise various types of insurance-related information that may be used to request a quote for insuring a risk and/or evaluating the terms of a policy insuring such risk. For example, in the illustrated embodiment, policy data 54 comprises aggregate policy data 60, risk data 62, weight data 64 and threshold data 66. Aggregate policy data 60 may comprise insurance-related information that is aggregated from a number of different policies from a number of different providers 12 across different risks and/or consumers. For example, aggregate policy data 60 may comprise premium values aggregated over time for a single provider 12 or for multiple providers 12 for a particular risk or risk factor(s) (e.g., a premium amount per vehicle insured). Risk data 62 may comprise information associated with a particular risk to be insured. For example, risk data 62 may comprise information associated with a policy for automobile insurance and may include information associated with the drivers of the vehicle, the ages of the drivers, the driving history of the drivers, the address where the vehicle/drivers reside, prior claims made for covered incidents, etc.

Weight data 64 comprises information associated with weighted values assigned to various policy-related risk factors and/or policy evaluation factors that are used to analyze an offer of an insurance policy (or a renewal thereof). For example, such factors may comprise a level of customer importance, a time period since a last review/analysis, tenure with an agency, line of business tenure with an insurance provider 12, cross-selling effectiveness of the agency, claims activity, change in zip code, change of vehicles, change of drivers, change of policy limits, change in traffic violations, change in premium, etc. It should be understood that the types of factors may vary based on the type of insurance product or other factors.

Weight data 64 may be applied to a level of customer/consumer importance. For example, some agencies may rate their customers on an order of importance. One example of this factor would be assigning three levels of importance to customers. The highest level (or most important) may include a small subset of customers which an agency flags as being the most important customers for the organization. These customers may receive this status for a number of different reasons including, but not limited to, personal line policies for a large commercial customer (i.e., commercial customer with over $25,000 in premiums), customers with large personal line premiums (i.e., over $7,500 in annual premiums), customers with a high income or high net worth (i.e., income over $100,000 or net worth over $500,000), customers who are celebrities (i.e., easily recognized, locally or nationally), customers who are politically influential (i.e., customers who serve on significant boards or associations or who may be in government positions), family members of the agency, etc. The high status/class level customers would have a very high weighting in the overall thresholds of risk factors. A mid-level importance may include the bulk of agency customers. The mid-level class of customers would receive a medium weighting in the overall thresholds of risk factors. The lowest level of customers may include customers that the agency does not deem very important (e.g., customers that generate minimal revenue but require significant time/resources). The lowest status/class level customers would have a very low weighting in the overall thresholds of risk factors (or no weighting at all).

A minimum amount of time since a last review for remarketing the insurance needs of a customer may also be evaluated and weighted. Customers may not want the impression that their insurance needs are marketed each and every year (or the agency may not want the customer to have an expectation that their insurance needs are marketed each and every year). Those customers having their insurance needs reviewed within the last year may be weighed very low such that the other factors would need to be significant in order to justify another review. However, the agency may want a high weight for customers who have not had their insurance needs reviewed in the past three years.

Tenure with an agency is another factor to consider. Tenure with an agency is an overall low weighting given the minimum time since last review factor above. However, an agency may want to review each and every customer on a particular interval (e.g., their 5th anniversary, regardless of all the other factors).

Line of business tenure with an incumbent insurance provider 12 is also considered. Similar to the minimum time since last review factor above, an agency may not want to set expectations that the agency will review a re-written policy unless the other factors are severe and significant. Provider loyalty credits may also be factor with this tenure. For example, the longer a customer stays with the same provider 12, the customer may become eligible for loyalty credits which make the rates appealing to remain with the same provider 12. As an example, if a customer is on their 4th renewal with a particular provider 12 that offers a 10% discount on their 5th renewal, the factor may be weighted lower in hopes of keeping the customer with the same provider.

Cross-selling effectiveness may also be considered. For example, the more lines of business an agency has for a customer, the more likely the customer will stay with the agency after a rate increase. For example, mono-line automobile customers tend to be price sensitive and are likely to only stay with an agency for three years. However, auto/home customers are likely to stay between 5-7 years on average. Umbrella customers (i.e., customers purchasing an umbrella policy in addition to their auto and home policies) are much more likely to stay with an agency when compared to a mono-line customer. Thus, the auto/home and/or umbrella factors may be weighted greater than a mono-line factor.

Claims activity may also be considered and weighted. For example, depending on the circumstances, a customer with a claim can be at high risk of receiving a rate increase. The most important factor with claims is the type and severity of the claim. Some providers 12 forgive the first property only loss, but raise the rates or cancel on any form of bodily injury claim.

A change in zip code or address/region/location may also be factor. A customer who moves is likely to see a change of premium (up or down). This factor may be weighted heavily if a customer moved to a more expensive territory.

Changes to vehicles may also be considered and weighted. A change to the vehicles on a policy is likely to result in a change of premium. The type of change (e.g., replacement, added or removed) may also be considered. When a vehicle is replaced with another on a policy (or deleted old then added new), there are several factors to consider in how the premium is likely to change. For example, a rating symbol (or symbol variation) may result in an increased premium (e.g., a customer trading in an economy car for a sports car). Age variation may also be factor (e.g., an older year model traded for a newer year model may result in a premium increase). For an added vehicle, when the total number of vehicles on the policy increases, several rate adjusting factors may apply. Additionally, a new driver may be added which might also have an impact on the rate/premium. For a removed vehicle, policies can be at risk when a new or expensive car is removed from a policy. A provider 12 may have a niche for sports cars, for example. However, the provider 12 may no longer be competitive once the sports car is removed from the policy.

A change of drivers (added/subtracted) may also impact the premium. A type of change may be weighted and evaluated. Youthful operators can increase the premium significantly. A provider 12 may apply the highest rated driver to the highest rated vehicle, thereby having the most significant change in the premium. Thus, adding a youthful operator may be weighted heavily as such a factor may result in a significant premium increase. Good student and driver education credits may also be weighted as these credits can impact the premium. A marital status change may also impact premiums, especially for drivers under the age of twenty-five. Thus, these factors that may significantly impact the premium may be heavily weighted.

A change of policy limits may also be weighted as customers typically do not change their coverage limits without some kind of life changing event (e.g., bankruptcy, marriage, divorce, youthful operator, driving under the influence violation, etc.). When limits change, the customer is likely at risk of an increased premium. Therefore, a policy limit change may be weighed heavily. An increase in a policy limit may be an indication that a customer is maturing. A decrease in a policy limit may be an indication that an increase in premium is beyond their financial means. Thus, these factors that may cause a significant change in premium may be weighted heavily.

A change in violations may also be weighted. While it may be difficult to determine if a customer has had any violations, a violation may be a significant rating change factor. Depending on the severity of the violation, a provider 12 may hold a rating factor for as many as three years for a minor violation (e.g., stop sign violation) and five years for a major violation (e.g., driving under the influence). Thus, different violation factors may be weighted differently (e.g., frequency of violations, severity of violation, and expired violations). For example, once violations fall off a customer's file, the rating becomes more competitive. Thus, each of these violation factors may be weighted heavily, if present, in evaluating a policy.

A change in premium does not necessarily equate to a policy being unreasonable or uncompetitive. There are many reasons for premiums changes which may be broken down into two large categories: 1) change in exposure; 2) a change in a provider 12's filed rate; and/or 3) a variation to a threshold. As indicated above, it is reasonable to expect premiums to change when the exposures change (as indicated in the example factors discussed above). However, just because the premiums change does not mean the customer is at risk. For example, adding a youthful driver or a sports car may double the overall auto premium. In some embodiments, there may be thresholds for acceptable premium increases given certain changes in exposure. (e.g., an increase of 50% may be considered reasonable to go from $1,200 premium for two vehicles to $1,800 for three vehicles). Conversely, if a customer removes a third vehicle and is left with two vehicles on a policy, and the premium only reduces by a 1/10 rather than by ⅓, then the customer may be at risk of having an unreasonable or uncompetitive policy. A change in a provider 12's filed rate, when compared to previous periods (e.g., how much a provider 12's average price is increasing or decreasing) may demonstrates changes in the base rating factors for a provider 12. These changes may be weighted heavily as this factor may be the most significant factor in predicting the cost of future policies. A variation to a threshold may also be considered. For example, the extent of an increase in premium a customer will absorb may be considered/weighted.

Threshold data 66 may comprise one or more threshold values used to determine whether to perform additional analysis of a policy and/or determine whether the consumer is at risk of overpaying for a particular insurance product. For example, in some embodiments, an increase in a premium (by a dollar amount or a percent increase) may be compared to a threshold value (dollar amount or percent value) to determine whether additional policy analysis should be performed. Threshold data 66 may also include a threshold value for comparison against a weighted value analysis. For example, as described further below, weight data 64 may be used to analyze various policy-related factors such that if a net value of the analysis exceeds the threshold value, the consumer may be at risk of overpaying for a particular insurance product.

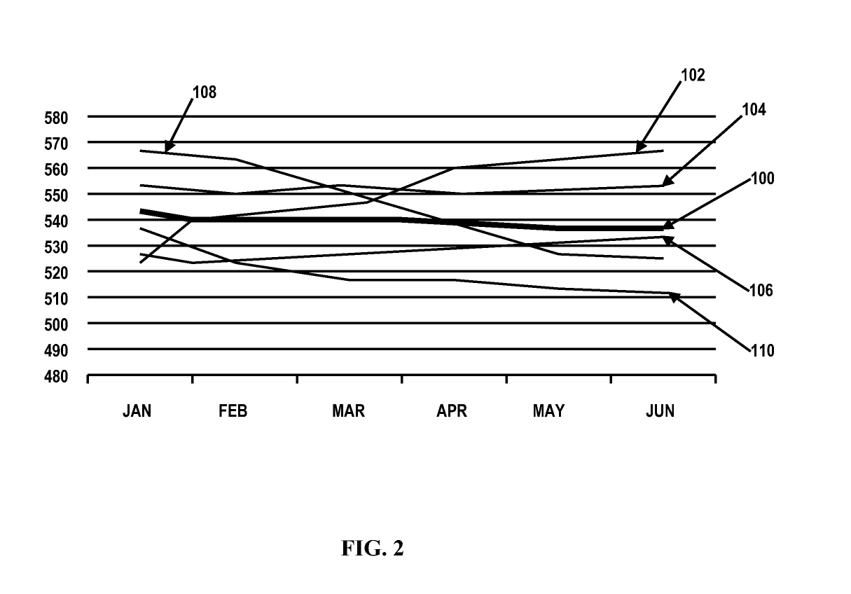

In some embodiments, analysis engine 52 gathers and uses aggregate policy data 60 to evaluate an offer of a policy of insurance. For example, in some embodiments, analysis engine 52 may use aggregate policy data 60 to generate and/or derive trend information for one or more insurance-related factors. FIG. 2 is a diagram illustrating an example chart depicting trend information related to an average cost per vehicle (premium) factor. Analysis engine 52 may generate the depicted trend information to compare a particular offer of insurance (original policy or renewal) to other policies (offered or in effect) in a particular rating territory area. In FIG. 2, the average cost per vehicle is represented by line 100 (benchmark). FIG. 2 illustrates that the benchmark is trending slightly lower and is currently about $537.

Provider A, as represented by line 102, is trending significantly upwards and is currently at about $567 or 5.51% over the benchmark 100. Further, provider A is more than 10.4% higher than provider E, at about $512 and represented by line 110, where provider E is continuing a downward trend. Thus, a customer with provider A may be considered at a much higher risk of having a policy considered unreasonable or above market conditions than other providers, especially provider E. Thus, analysis engine 52 may identify an offer of a policy with provider A as a risk that should be re-marketed with other providers 12.

Provider B, as represented by line 104, is trending flat and is currently at about $551 or $14 over the benchmark 100. While provider B is holding steady just above the benchmark 100, there would still be some risk, especially if a renewal was more than a few dollars above its expiring premium.

Provider C, as represented by line 106, is below the benchmark 100 but trending upwards at a current rate of about $532, just $5 under the benchmark 100 of $537. There is still a small amount of risk in renewing a policy with provider C, especially if changes are expected later in the term. Assuming the trend continued, provider C will likely be above the benchmark 100 in a few short months.

Provider D, as represented by line 108, is aggressively moving below the benchmark 100 at about $525. Provider E, as represented by line 110, is slowly and steadily trending lower well below the benchmark 100 and is current at about $512. If the customer is at risk and with either provider A or provider B, then provider E may be a reasonable alternative for the customer.

Thus, in some embodiments, depending on the policy offer as compared to an analysis of information with various other providers 12, analysis engine 52 may identify the policy offer as being at risk of an excessively high premium for the insured risk. If so, analysis engine 52 may initiate and/or launch quoting engine 50 to seek quotes from other providers 12.

Table 1 indicated below depicts an exemplary weighting applied to various insurance-related factors (discussed above). As indicated in Table 1, the weighting may include positive weighting, negative weighting, or no weighting for certain factors.

TABLE 1

| | Points |
|---|---|
| Customer Designation | |
| First Class | 100 |
| Second Class | 0 |
| Third Class | −100 |
| Minimum Time Since Last Review for Remarketing | |
| 1 Year | −100 |
| 2 Years | −75 |
| 3 Years | 0 |
| 4 or more Years | 25 |
| Tenure with Agency | |
| 1-2 Years | −25 |
| 3-5 Years | 0 |
| 5-7 Years | 25 |
| More than 7 Years | 50 |
| LOB Tenure with Incumbent Provider | |
| 1 Years | −100 |
| 2 Years | −75 |
| 3-4 Years | 0 |
| More than 4 Years | −50 |
| Consider Carrier Loyalty Credits | |
| Cross Selling Effectiveness | |
| Mono-line Automobile | −50 |
| Auto/Home Customer | 0 |
| Umbrella Customer | 50 |
| Claims Activity | |
| No Activity | 0 |
| Activity | 50 |
| Change in Zip Code | 50 |
| Change of Vehicles | |
| Replacement Vehicle | |
| Symbol Variation High | 50 |
| Age Variation High | 25 |
| Added Vehicle | 50 |
| Removed Vehicle | 0 |
| Change of Drivers | |
| Youthful Operators | 100 |
| Good Students & Drivers Education Credits | −50 |
| Marital Status Change | 50 |
| Change of Limits | |
| Limits Increased | 50 |
| Limits Decreased | 25 |
| Change in Violations | |
| Frequency of Violations High | 50 |
| Severity of Violations High | 100 |
| Expired Violations | 75 |
| Change in Premium | |
| Change in Exposure Above | −50 |
| Change in Provider's Filed Rate | 100 |
| Variation to Threshold High | 100 |

Tables 2 and 3 below depict two examples of how analysis engine 52 applies the weighting values depicted in Table 1 to the indicated factors. In some embodiments, a threshold of points may be set that would trigger an automated remarketing process for a policy. For example, for the examples depicted in Tables 1 and 2, a threshold of plus or minus 100 points is set. In the first example indicate in Table 1, the net points is equal to 250 points, thereby initiating the automated review/remarketing. In the example depicted in table 3, the net points is equal to −75, which would not initiate an automatic review/remarketing.

TABLE 2
Sample Weighting (first class customer buys
a new car and premium increases $850)

| | | |
|---|---|---|
| Customer Designation | 1^{st} class | 100 |
| Minimum Time Since Last Review | 3 Years | 0 |
| Tenure with Agency | 5 Years | 0 |
| LOB Tenure with Incumbent Provider | 3 Years | 0 |
| Cross Selling Effectiveness | Umbrella | 50 |
| Claims Activity | None | 0 |
| Change in Zip code | None | 0 |
| Change of Vehicles | New | 0 |
| Added Vehicle | Yes | 50 |
| Change of Drivers | None | 0 |
| Change of Limits | None | 0 |
| Change in Violations | None | 0 |
| Change in Premium | 850 | |
| Change in Exposure Above | 600 | −50 |
| Change in Provider's Filed Rate | None | |
| Variation to Threshold Set | 200 | 100 |
| | | 250 |

TABLE 3
Sample Weighting (standard customer receives
speeding ticket, premium increases $100)

| | | |
|---|---|---|
| Customer Designation | 2^{nd} class | 0 |
| Minimum Time Since Last Review | 2 Years | −75 |
| Tenure with Agency | 3 Years | 0 |
| LOB Tenure with Incumbent Provider | 1 Years | −50 |
| Cross Selling Effectiveness | Auto/Home | 0 |
| Claims Activity | None | 0 |
| Change in Zip code | None | 0 |
| Change of Vehicles | New | 0 |
| Added Vehicle | Yes | 0 |
| Change of Drivers | None | 0 |
| Change of Limits | None | 0 |
| Change in Violations | Minor | 50 |
| Change in Premium | 100 | |
| Change in Exposure Above | 0 | 0 |
| Change in Provider's Filed Rate | None | 0 |
| Variation to Threshold Set | 200 | 0 |
| | | −75 |

In some embodiments, analysis engine 52 may also automatically compare different policies and automatically identify/indicate differences between the compared policies. For example, system 10 may be configured to access system(s) 14 to retrieve (or obtain from system 14) policy data 54 for a particular customer. The customer may have an existing policy with a particular provider 12. Near the end of the term of the existing policy, a renewal policy may be issued by the provider 12. Analysis engine 52 is configured to automatically compare the existing policy with the renewal policy to automatically identify differences between the policies. Such differences may be the identification of a traffic violation, addition of a driver, etc. (e.g., any of the above-referenced weighted factors discussed above). Analysis engine 52 may also include text recognition functionality to identify and decipher handwritten, typed or other types of data from freeform sections/blocks of a policy. Analysis engine 52 extracts information from the policy and automatically analyzes the policy using the weight data 64 described above. Analysis engine 52 identifies changes to the policy and automatically applies the weight values to any discovered differences (as well as applying weighted values to any previously identified factors). Depending on whether a net value of the weighted factor analysis is greater than (plus or minus) a threshold value (e.g., as indicated in Tables 2 and 3), analysis engine 52 may automatically flag the policy for remarketing (e.g., obtaining quotes from different providers 12). Analysis engine 52 may also automatically generate a display of the differences between compared policies to enable an agent to quickly identify and/or verify such differences.

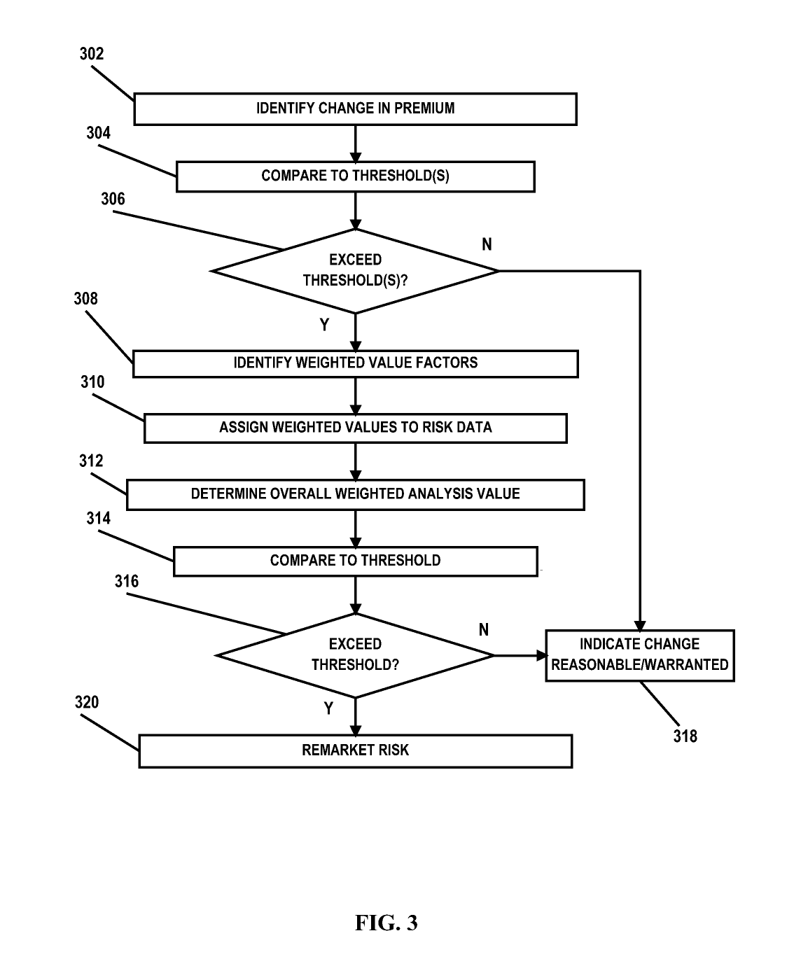

FIG. 3 is a flow diagram illustrating an embodiment of a method for insurance policy management. At block 302, analysis engine 52 receives a policy to evaluate and identifies any premium change in the policy. For example, in the flow diagram depicted in FIG. 3, the policy to be analyzed is a renewal policy such that a premium comparison may be made to the premium paid for the current, in-effect policy. At block 304, analysis engine 52 compares the change/difference in premium to a threshold value(s). For example, the change/difference in premium may be compared to a dollar threshold value and/or a percent value. In some embodiments, both thresholds are used such that a further analysis is performed only if the change/difference exceeds both thresholds. In some embodiments, if the policy being evaluated is a new policy, the premium could be compared to aggregate policy data 60 (e.g., a benchmark or average premium value).

At decisional block 306, a determination is made whether the change/difference in premium exceeds the threshold(s). If not, the method proceeds to block 318, where an indication is generated by analysis engine 52 that the change in premium is reasonable or warranted in view of the risk factors. If a determination is made at decisional block 306 that the change/difference in premium exceeds the threshold(s), the method proceeds to block 308, where analysis engine 308 identifies the risk factors of the policy (e.g., added driver, youthful driver, added vehicle, etc.). Analysis engine 308 may extract the risk factors from the policy, retrieve/receive the factors from another source (e.g., a remote device/system that may contain driving history information or other risk-related information) and/or otherwise receive the risk-related information. At block 310, analysis engine 52 assigns the weighted values to the risk data factors (e.g., 100 points if first class customer). At block 312, analysis engine 52 determines an overall weighted analysis value/score (e.g., by summing the weighted values/points assigned to the risk factors). At block 314, analysis engine 52 compares the overall weighted analysis value to a threshold.

At decisional block 316, a determination is made whether the overall weighted analysis value exceeds the threshold. If not, the method proceeds to block 318, where an indication is generated by analysis engine 52 that the change in premium is reasonable or warranted in view of the risk factors. If a determination is made at decisional block 316 that the overall weighted analysis value exceeds the threshold, the method proceeds to block 320, where analysis engine 52 invokes quoting engine 50 to remarket the risk to other providers 12 (e.g., by requesting quotes from other providers 12 based on the risk data 62 for the consumer).

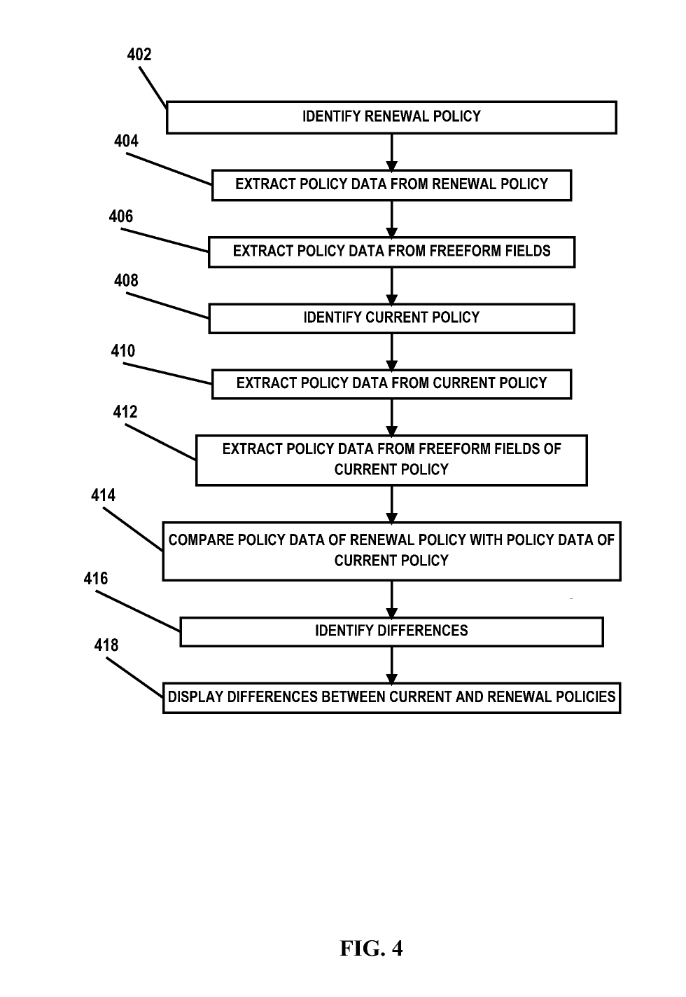

FIG. 4 is a diagram illustrating another embodiment of a method for insurance policy management. At block 402, analysis engine 52 identifies a renewal policy to analyze. Analysis engine 52 may be automatically invoked in response to system 10 receiving a renewal policy from one of providers 12. For example, in some embodiments, providers 12 may have corresponding systems 14 configured to automatically download or push policy information, including offers of renewals, to systems of an agency managing such policies. Thus, in some embodiments, in response to receiving a policy renewal from a respective provider 12, analysis engine 52 is automatically invoked to initiate an analysis and comparison of the renewal policy with an existing, currently in effect policy. In some embodiments, a user may also select/identify a renewal policy for analysis. At block 404, analysis engine 52 automatically extracts policy data 54 from the renewal policy. The types of policy data 54 extracted may be set by an administrator of the agency and/or otherwise configured. The types of policy data 54 extracted may include risk data 62. The renewal policy may be in electronic format and have certain fields such that data may be readily extracted from such fields. The renewal policy may also be in an electronic format but have certain freeform fields such that freeform text or other types of data may not be readily extracted therefrom. Analysis engine 52 may comprise text recognition code and/or functionality to analyze content within the freeform fields and derive the data contained therein. Analysis engine 52 may also parse the information contained in the freeform field(s) and derive information therefrom (e.g., identify parsed content derived from the freeform fields and determine a best match/meaning of the parsed content for comparison purposes). Thus, at block 406, analysis engine 52 extracts and derives policy data from the renewal policy from freeform content fields.

At block 408, analysis engine 52 identifies a current policy for the customer (i.e., the customer associated with the renewal policy). Analysis engine 52 may be configured to cross-reference and/or otherwise identify relational information (e.g., from a database) to identify a corresponding type of policy for a same customer (e.g., an automobile policy for customer A). At block 410, analysis engine 52 automatically extracts policy data 54 from the current policy. At block 412, analysis engine 52 extracts and derives policy data from the current policy from freeform content fields (e.g., similar to the renewal policy as described above). At block 414, analysis engine 52 compares the extracted policy data for the current and renewal policies. At block 416, analysis engine 52 identifies differences between the compared policies. At block 418, analysis engine 52 automatically displays the differences between the current and renewal policies.

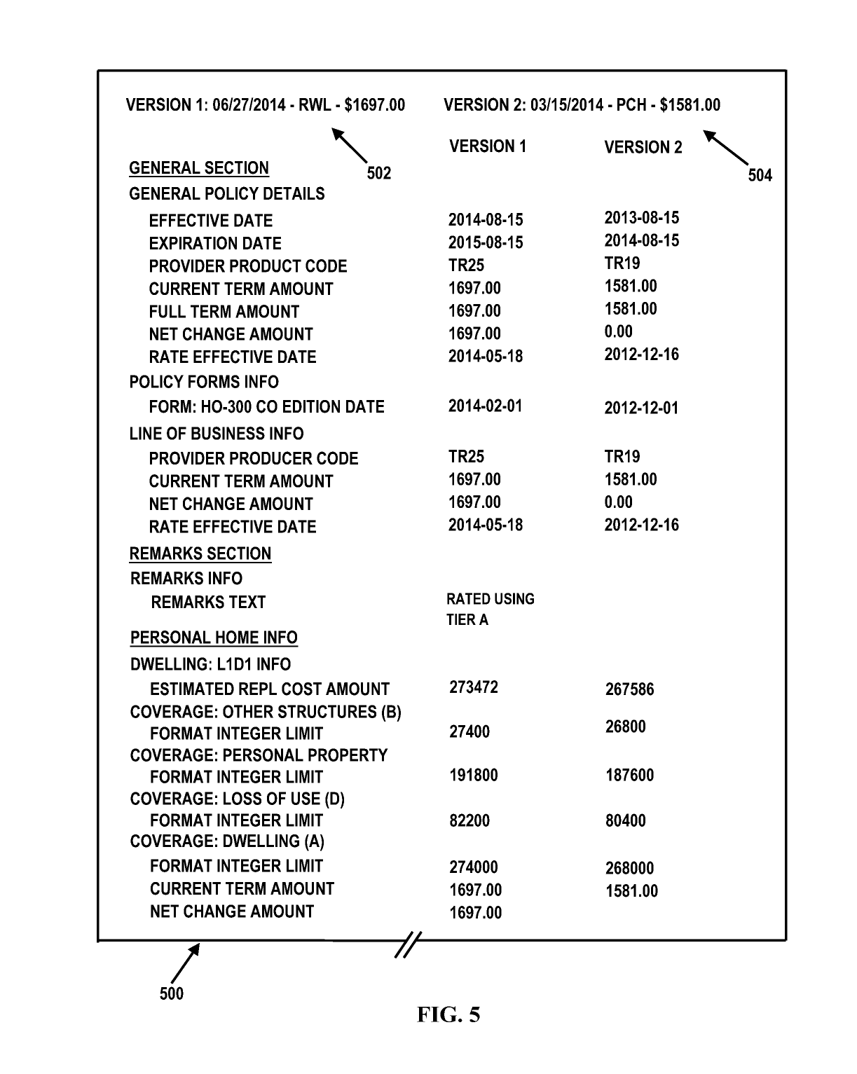

FIG. 5 is a diagram illustrating a display 500 of compared policy information using analysis engine 52 according to the present disclosure. The compared policies may be a current and renewal policy for a particular customer (e.g., from a particular provider 12), policies from different providers 12 for a particular risk and/or customer, and/or different versions of a particular policy (e.g., with one or more elements changed, such as a coverage level). For example, in FIG. 5, two different versions 502 and 504 of a policy are being compared (in this example, a renewal policy). As depicted in FIG. 5, analysis engine 52 extracts various types of information from each policy (e.g., risk data 62), and/or derives information from various fields of the policies, and compares corresponding terms to identify differences between the versions 502 and 504 of the policy. Analysis engine 52 displays the various extracted terms, and/or differences between them, to enable a user to readily identify the differences between the compared versions 502 and 504 of the policies. In the illustrated embodiment, a freeform field identified by “Remarks” contained text that was derived to indicate “Rated using Tier A”. It should be understood that the type of information that may be derived from freeform fields may vary.

It should be understood that in the described methods, certain functions may be omitted, accomplished in a sequence different from that depicted in FIGS. 3 and 4, or simultaneously performed. Also, it should be understood that the methods depicted in FIGS. 3 and 4 may be altered to encompass any of the other features or aspects as described elsewhere in the specification.

Further, embodiments may be implemented in software and can be adapted to run on different platforms and operating systems. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), and a memory stick. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

What is claimed is:

1. A policy management system, comprising:
a processor; and
an analysis module executable by the processor, the analysis module configured to identify risk factors associated with a policy of insurance offered by an insurance provider for a risk, the analysis module configured to apply weighted values to the identified risk factors, and wherein the analysis module is configured to combine the applied weighted values to determine whether the risk should be marketed to another insurance provider.

2. The system of claim 1, wherein at least one of the risk factors is a change in a premium, and wherein a weighted value is applied to the change in premium based on a basis for the change in premium.

3. The system of claim 1, wherein the analysis module is configured to compare a premium for the policy with a benchmark premium, the benchmark premium derived from aggregate data representing premiums from a plurality of insurance providers for a similar risk.

4. The system of claim 1, wherein the analysis module is configured to sum the weighted values and determine if a sum of the weighted values exceeds a threshold.

5. The system of claim 4, wherein the weighted values comprise positive weight values and negative weight values.

6. The system of claim 1, wherein the analysis module is configured to extract the risk factors from the policy and compare the risk factors with another policy of insurance for the risk.

7. The system of claim 6, wherein the another policy comprises a renewal policy for the risk from the insurance provider.

8. A policy management method, comprising:
interfacing with a data processing system of an insurance provider to obtain an offer of a policy of insurance for a risk;
identifying, by an analysis module of a policy management system, risk factors associated with the risk;
applying, by the analysis module, weighted values to the identified risk factors; and
combining, by the analysis module, the applied weighted values to determine whether the risk should be marketed to another insurance provider.

9. The method of claim 8, wherein at least one of the risk factors is a change in a premium, and wherein a weighted value is applied to the change in premium based on a basis for the change in premium.

10. The method of claim 8, further comprising comparing, by the analysis module, a premium for the policy with a benchmark premium, the benchmark premium derived from aggregate data representing premiums from a plurality of insurance providers for a similar risk.

11. The method of claim 8, further comprising:
summing, by the analysis module, the weighted values; and
determining, by the analysis module, if a sum of the weighted values exceeds a threshold.

12. The method of claim 11, wherein the weighted values comprise positive weight values and negative weight values.

13. The method of claim 8, further comprising:
extracting, by the analysis module, the risk factors from the policy; and
comparing, by the analysis module, the risk factors with another policy of insurance for the risk.

14. The method of claim 13, wherein the another policy comprises a renewal policy for the risk from the insurance provider.

15. A computer program product for policy management, the computer program product comprising a computer readable storage medium having program instructions embodied therewith, the program instructions executable by a processor to cause the processor to:
interface with a data processing system of an insurance provider to obtain an offer of a policy of insurance for a risk;
identify risk factors associated with the risk;
apply weighted values to the identified risk factors; and
combine the applied weighted values to determine whether the risk should be marketed to another insurance provider.

16. The computer program product of claim 15, wherein the instruction set, when executed by the processor, causes the processor to identify at least one of the risk factors as a change in a premium, and wherein a weighted value is applied to the change in premium based on a basis for the change in premium.

17. The computer program product of claim 15, wherein the instruction set, when executed by the processor, causes the processor to compare a premium for the policy with a benchmark premium, the benchmark premium derived from aggregate data representing premiums from a plurality of insurance providers for a similar risk.

18. The computer program product of claim 15, wherein the instruction set, when executed by the processor, causes the processor to:
sum the weighted values; and
determine if a sum of the weighted values exceeds a threshold.

19. The computer program product of claim 18, wherein the instruction set, when executed by the processor, causes the processor to use positive weight values and negative weight values.

20. The computer program product of claim 15, wherein the instruction set, when executed by the processor, causes the processor to:
extract the risk factors from the policy; and
compare the risk factors with another policy of insurance for the risk.
